(19) United States
(12) Patent Application Publication
(10) Pub. No.: US 2026/0307986 A1
(43) Pub. Date: Oct. 8, 2026

(54) COMBINED HYDROGEN PRODUCTION AND SUSTAINABLE FUELS PRODUCTION

(71) Applicant: Lummus Technology LLC, Houston, TX (US)

(72) Inventors: Daniel Bruce Gillis, Houston, TX (US); James Small, Houston, TX (US); Christine Conway, Houston, TX (US)

(73) Assignee: Lummus Technology LLC, Houston, TX (US)

(21) Appl. No.: 19/629,959

(22) Filed: Mar. 26, 2026

Related U.S. Application Data
(60) Provisional application No. 63/782,380, filed on Apr. 2, 2025.

(51) Int. Cl. C01B 3/24; C10G 45/58

(52) U.S. Cl. CPC C01B 3/24; C10G 45/58; C01B 2203/062; C01B 2203/0833; C01B 2203/1241

(57) ABSTRACT

Embodiments herein relate to systems and processes for producing fuels. The systems and processes include converting a hydrocarbon feed in a furnace of a hydrogen plant to produce hydrogen. The systems and processes further include heating a thermal oil in a convection zone of the furnace to produce a heated thermal oil. The hydrogen and a hydrocarbon feedstock are reacted and separated in a hydroprocessing plant to recover one or more fuel fractions, where, in the hydroprocessing plant, heat is provided for the reacting and separating using the heated thermal oil. In some embodiments, the hydroprocessing plant does not include a fuel combusting furnace.

### FIELD OF THE DISCLOSURE

Embodiments of the present disclosure generally relate to the production of fuels, such as sustainable aviation fuels (SAF) and renewable diesel (RD) fuels, among others.

### BACKGROUND

Aviation fuels are currently being produced from fossil-based feedstocks (e.g., crude oil) and renewable feedstocks, such as hydrotreated esters and fatty acids (HEFA), among other biological-based or renewable feedstocks. The deployment of more sustainable aviation fuels means that more bio-based feedstock material must be made available globally to supply sustainable fuels to both the aviation industry and road transportation sector. Producing sustainable fuels, however, should be performed in an environmentally friendly manner, with as small a carbon footprint as possible.

### SUMMARY OF THE CLAIMED EMBODIMENTS

In one aspect, embodiments disclosed herein relate to a process for producing fuels. The process includes converting a hydrocarbon feed in a reforming reactor furnace of a hydrogen plant to produce hydrogen. The process further includes heating a thermal oil in a convection zone of the furnace to produce a heated thermal oil. The hydrogen and a hydrocarbon feedstock are reacted and the reaction products are separated in a hydroprocessing plant to recover one or more fuel fractions, where, in the hydroprocessing plant, heat is provided for the reacting and separating using the heated thermal oil. In some embodiments, the hydroprocessing plant does not comprise a fuel combusting furnace.

In another aspect, embodiments disclosed herein relate to a process for producing fuels. The process includes combusting a fuel and preheated combustion air in a reforming reactor furnace comprising a combustion zone and a convection zone receiving a flue gas from the combustion zone. In the convection zone, a hydrocarbon feed is preheated to form a preheated hydrocarbon feed, combustion air is preheated to provide the preheated combustion air; water is heated to make steam, and a thermal oil is heated to form a heated thermal oil. The preheated hydrocarbon feed is converted in the reforming reactor, and optionally within a water-gas shift reactor, to produce hydrogen. The hydrogen and a hydrocarbon feedstock are then fed to a hydroprocessing reaction zone comprising one or more hydroprocessing reactors, wherein the hydrogen and the hydrocarbon feedstock are reacted in the one or more hydroprocessing reactors to produce a hydroprocessed effluent comprising fuel range hydrocarbons having from 6 to 24 carbon atoms (C₆ to C₂₄ hydrocarbons). The hydroprocessed effluent is then separated in one or more separators to recover one or more fuel fractions. In embodiments herein, the reacting and separating steps comprise one or more of: preheating the hydrogen upstream of a reactor of the one or more hydroprocessing reactors using the heated thermal oil; preheating the hydrocarbon feedstock upstream of a reactor of the one or more hydroprocessing reactors using the heated thermal oil; heating a reboiler of a separator of the one or more separators using the heated thermal oil; and heating a feed to a separator of the one or more separators using the heated thermal oil.

In another aspect, embodiments disclosed herein relate to a system for producing fuels. The system includes a reforming reactor furnace comprising a combustion zone, for combusting a fuel and preheated combustion air, and a convection zone, configured for receiving a flue gas from the combustion zone. One or more heating coils are disposed within the convection zone and configured for: preheating a hydrocarbon feed to form a preheated hydrocarbon feed; preheating combustion air to provide the preheated combustion air; heating water to make steam; and heating a thermal oil to form a heated thermal oil. Reaction tubes are disposed within the reforming reactor furnace for converting the preheated hydrocarbon feed to produce a reformer effluent comprising hydrogen. A flow line or flow lines are provided for feeding the hydrogen and a hydrocarbon feedstock to a hydroprocessing reaction zone comprising one or more hydroprocessing reactors. The one or more hydroprocessing reactors are configured for reacting the hydrogen and the hydrocarbon feedstock to produce a hydroprocessed effluent comprising fuel range hydrocarbons having from 6 to 24 carbon atoms (C₆ to C₂₄ hydrocarbons). Further, the system includes one or more separators for separating the hydroprocessed effluent to recover one or more fuel fractions. In embodiments herein, the system comprises one or more of: a first heat exchanger for preheating the hydrogen using the heated thermal oil, wherein the first heat exchanger is disposed upstream of a reactor of the one or more hydroprocessing reactors; a second heat exchanger for preheating the hydrocarbon feedstock using the heated thermal oil, wherein the second heat exchanger is disposed upstream of a reactor of the one or more hydroprocessing reactors; a reboiler, configured for providing reboil vapor to a separator of the one or more separators using heat obtained the heated thermal oil; and a third heat exchanger configured for heating a feed to a separator of the one or more separators using the heated thermal oil.

Other aspects and advantages will be apparent from the following description and the appended claims.

### BRIEF DESCRIPTION OF DRAWINGS

FIG. 1 illustrates a block flow diagram of a process for producing hydrogen and hydroprocessing a renewable feedstock according to one or more embodiments disclosed herein.

FIG. 2 illustrates a simplified process flow diagram of a hydroprocessing plant useful in processes according to one or more embodiments disclosed herein.

FIG. 3 illustrates a simplified process flow diagram of a hydrogen manufacturing plant useful in processes according to one or more embodiments disclosed herein.

FIG. 4 illustrates a simplified process flow diagram of a pretreatment facility useful in processes according to one or more embodiments disclosed herein.

### DETAILED DESCRIPTION

Embodiments herein relate to the production of sustainable fuels, such as sustainable aviation fuel (SAF), Renewable Diesel (RD), green hydrogen and other fuels. More specifically, embodiments herein relate to the production of sustainable fuels using integrated processes including both hydrogen production and hydroprocessing, which may include both hydrotreatment and isomerization of a renewable feedstock. The hydrogen production and the hydroprocessing systems and processes herein are integrated with respect to both feeds and utilities, thereby providing an efficient process, having a low carbon footprint, for producing sustainable fuels. In other embodiments, the hydrogen production, the hydroprocessing systems and processes, and feed pretreatment systems and processes herein are integrated with respect to both feeds and utilities, thereby providing an efficient process, having a low carbon footprint, for producing sustainable fuels.

### Hydrogen Production

Hydrogen can be supplied from a hydrogen plant, a catalytic reforming facility, or other hydrogen-producing processes. In some embodiments, the hydrogen plant includes a fuel-fired reactor, such as a fuel-fired reforming reactor.

In one or more embodiments, the fuel-fired reforming reactors may be configured to accept 100% hydrogen to 100% methane as fuel. When methane is used as fuel, any produced flue gas will contain CO₂. The flue gas may be directed to a carbon capture system to remove any CO₂, thus minimizing any possible CO₂ emissions. In other embodiments, the fuel-fired reforming reactors may be configured to accept a range of fuels. The fuels may include hydrogen, carbon monoxide (e.g., partially combusted flue gas from other processes at the facility), methane, ethane, natural gas, or combinations thereof. In some embodiments, fuels, such as hydrogen or methane, may be separated from the hydroprocessing system (described below) and fed to the fuel-fired reactors of the hydrogen plant.

In one or more embodiments, the reforming reactor may be an autothermal reformer. The autothermal reformer may use pure oxygen for combustion in some embodiments. The pure oxygen, or an enriched oxygen, may be provided by an air separation unit (ASU) in some embodiments, or may be imported to the facility in others. Air may also be used to provide the oxygen required for combustion.

The reforming unit may be configured to convert methane in a methane stream to produce a reformer effluent comprising hydrogen and one or more of unreacted methane, carbon monoxide and carbon dioxide. Carbon monoxide and hydrogen may be produced in the reforming reactor, as shown in Reaction 1.

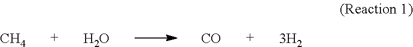

The steam reforming unit may include reforming reactors and a water-gas shift reactor in some embodiments. The water-gas shift reactor may convert carbon monoxide and water to carbon dioxide and hydrogen. The reaction is the water-gas shift reaction, as shown in Reaction 2.

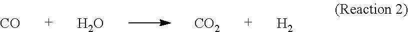

Other hydrocarbons, such as ethane, propane, butanes, a naphtha range hydrocarbons may also be used for hydrogen production, although the ratio of hydrogen to carbon oxides decreases with increasing carbon number.

The effluent from the reformer, or from the water-gas shift reactor, may then be separated to recover hydrogen. The hydrogen plant separation system may be configured to recover a hydrogen stream, a carbon dioxide stream, and an unreacted hydrocarbon stream, and may include various units such as a carbon capture system, a pressure swing adsorption system, a membrane adsorption system, and combinations thereof. High purity hydrogen may be recovered from the combination of the carbon capture system, a pressure swing adsorption system, and a membrane adsorption system. Hydrogen recovered from the hydrogen plant separation system may include hydrogen having a purity of at least 99.9 mol % in some embodiments.

The fuel-fired reactor(s) in the hydrogen plant are used, according to embodiments herein, to heat a thermal oil that is used to provide the heat of reaction and perform separations in the hydroprocessing facility, as will be described below. The hydrogen recovered from the hydrogen plant is used as a hydrogen feed to the hydroprocessing plant, and, as noted above, the light hydrocarbon products (methane, ethane, propane, butanes, and/or naphtha range hydrocarbons) may be used as feeds to the hydrogen plant, either as fuels or as feeds used to produce hydrogen.

### Hydroprocessing

The hydroprocessing plant is used to convert a hydrocarbon feedstock, such as a renewable feedstock, utilizing the heated thermal oil, the hydrogen, and optionally steam received from the hydrogen plant. Other various hydrocarbon feedstocks may be processed in manners similar to the processes described herein, including pyrolysis oils generated from renewable feedstocks, and other hydrocarbon feedstocks that may be hydroprocessed using thermal oil heating at similar conditions as disclosed herein to produce sustainable aviation fuels and renewable diesel, among other renewable fuels.

### Renewable Feedstocks

Renewable feedstock useful in embodiments herein include feedstocks derived from biological raw materials. The sources for renewable feedstock are numerous, and may include oils and/or fats, usually containing lipids (e.g. fatty acids or glycerides), such as plant oil/fats, vegetable oil/fats, animal oil/fats, algae oil/fats, fish oil/fats and algae oil/fats, or oil/fats from other microbial processes, for example, genetically manipulated algae oil/fats, genetically manipulated oil/fats from other microbial processes and also genetically manipulated vegetable oil/fats. Components of these materials may also be used, for example, alkyl esters, typically C1-C5 alkyl esters, such as methyl, ethyl, propyl, iso-propyl, butyl, sec-butyl esters, or olefins. Additionally, the renewable feedstock may include C1-C5 alkyl alcohols, particularly methyl, ethyl, propyl, iso-propyl, butyl, and/or sec-butyl esters of fatty acids, and any combinations thereof.

The renewable feedstock may additionally include free fatty acids, fatty acid esters (including mono-, di-, and triglycerides), or combinations thereof. For example, the free fatty acids may include free fatty acids obtained by stripping free fatty acids from a triglyceride transesterification feedstock. The renewable feedstock may include the fatty acid distillates from vegetable oil deodorization. Depending on level of pretreatment, fats, oils, and greases may contain impurities, such as between about 1 wppm and about 1,000 wppm phosphorus, and between about 1 wppm and about 500 wppm total metals, mainly sodium, potassium, magnesium, calcium, iron, and copper. Plant and/or vegetable oils and/or microbial oils may include babassu oil, carinata oil, soybean oil, canola oil, coconut oil, rapeseed oil, crude tall oil (CTO), tall oil (TO), tall oil fatty acid (TOFA), tall oil pitch (TOP), palm oil (PO), palm oil fatty acid distillate (PFAD), jatropha oil, palm kernel oil, sunflower oil, castor oil, camelina oil, archaeal oil, bacterial oil, fungal oil, protozoal oil, algal oil, seaweed oil, oils from halophiles, and mixtures of any two or more thereof. These oils may have been classified as crude, degummed, and RBD (refined, bleached, and deodorized) grade, depending on the level of pretreatment and residual phosphorus and metals content. Animal fats and/or oils may include inedible tallow, edible tallow, technical tallow, floatation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof.

In general, renewable feedstocks useful in embodiments herein comprise C10-C24 fatty acids and derivatives thereof, including esters of fatty acids, glycerides, i.e. glycerol esters of fatty acids. The glycerides may include monoglycerides, diglycerides and triglycerides. In some embodiments, the feedstock includes waste and residue material originating from animal fat/oil, plant fat/oil such as palm oil and derivatives thereof and used cooking oil (UCO).

Renewable feedstocks used in embodiments herein may include a single kind of oil, a single kind of fat, mixtures of different oils, mixtures of different fats, mixtures of oil(s) and fat(s), fatty acids, glycerol, and/or mixtures of the aforementioned. In some embodiments, when renewable feedstocks including waste and residue material are processed using systems and processes herein, the renewable feedstocks comprise mixtures of several components.

In various embodiments, the renewable feedstocks contain C8-C22 hydrocarbons, C10-C20 hydrocarbons, or C15-C18 hydrocarbons. In some embodiments, a renewable feedstock includes waste and residue materials originating from animal fat/oil, plant fat/oil or fish fat/oil. These oils may include sludge palm oil, such as palm effluent sludge (PES) or palm oil mill effluent (POME), used cooking oil (UCO), acid oils (ASK), brown grease (BG), sludge palm oil, spent bleaching earth oil (SBEO), technical corn oil (TCO) or lignocellulosic based oils, municipal solid waste-based oils, or algae-based oils. Most preferably, the feeds include UCO, sludge palm oil, TCO and algae-based oils.

Prior to hydroprocessing of the renewable feedstocks, it may be desirable to pre-treat the renewable feedstocks to make them more suitable for hydroprocessing.

### Pretreatment

In general, renewable feedstocks contain a wide variety of heteroatomic compounds, which often are more difficult to remove by conventional feedstock pre-treatments typically used for pre-treatment of compositions including triacylglycerols. The waste and residue materials may include accumulated alkali and alkaline earth metals, such as sodium, potassium, calcium, magnesium; other metals such as iron or copper; nitrogen containing compounds, such as amines and amides; phosphorus containing compounds, such as phospholipids; silicon containing compounds, such as siloxanes and polydimethylsiloxanes (PDMS); halides; sulfur containing compounds; etc. depending on the type of residue/waste. These materials are typically harmful for the catalyst used in the hydroprocessing system (hydrotreatment/hydrodeoxygenation and isomerization) and need to be decreased or removed before entering the feedstock onto the catalysts.

Depending on the level of pre-treatment, fats, oils, and greases may contain high amounts of impurity materials, such as about 1-1000 ppmw (ppm by weight) phosphorus; and about 1-500 ppmw total metals, mainly sodium, potassium, magnesium, calcium, iron, and copper. Animal fat can contain, for example, 1000 ppmw or even higher nitrogen measured as elemental nitrogen.

The feedstocks need to be pretreated to make them suitable for hydrodeoxygenation. Typically, the feedstock entering into a hydrodeoxygenation reactor or a catalyst bed thereof should not include more than 10 ppmw, preferably not more than 5 ppmw, more preferably not more than 1 ppmw alkali metal and alkaline earth metal impurities, calculated as elemental alkaline and alkaline earth metals; not more than 10 ppmw, preferably not more than 5 ppmw, more preferably not more than 1 ppmw other metals, calculated as elemental metals; not more than 1000 ppmw, preferably not more than 500 ppmw, more preferably not more than 150 ppmw, most preferably not more than 50 ppmw, such as not more than 5 ppmw, such as not more than 1 ppmw nitrogen containing impurities, calculated as elemental nitrogen; not more than 5 ppmw, such as not more than 3 ppmw, mor preferably not more than 1 ppmw phosphorus containing impurities, calculated as elemental phosphorus; not more than 5 ppmw, preferably not more than 1 ppmw silicon containing impurities, calculated as elemental silicon; optionally not more than 100 ppmw, preferably not more than 50 ppmw, most preferably not more than 30 ppmw, such as not more than 10 ppmw, such as not more than 5 ppmw sulfur containing impurities, calculated as elemental sulfur, and optionally not more than 20 ppmw, preferably not more than 10 ppmw, more preferably not more than 5 ppmw chlorine (halogen) containing impurities, calculated as elemental chlorine (halogen).

There are several known methods to remove or decrease the content of harmful materials, and varying purification or pre-treatment methods are commonly applied. Exemplary pre-treatment methods suitable for use in pretreatment systems according to embodiments herein may include treating with mineral acids, degumming, treating with hydrogen, heat treating, deodorizing, washing with water, treating with base, demetallation, distillation, removal of solids, bleaching, and any combinations thereof.

Contaminating metals may be removed from the feedstock by treatment with mineral acids, for example. Phosphorous, which mostly occurs in the form of phosphates, may be removed by degumming. Triglycerides can also be pre-hydrogenated (pre-treated with hydrogen). Besides reducing the amount of oxygen containing compounds (HDO), unsaturation, sulfur, and nitrogen content (HDS, HDN) are reduced in the pretreatment. Solid feedstocks such as fats, in turn, should be liquified such as by heating prior to subjecting to hydrodeoxygenation. Pre-treatment of solid feedstocks may further include one or more of: grinding, agitating, filtering, and sonicating. The feedstock may further be bleached and/or deodorized.

The pre-treatment can be selected from heat treatment optionally followed by evaporation of volatiles; heat treatment with adsorbent (HTA), optionally followed by flash evaporation; degumming; bleaching. According to one embodiment the pre-treatment includes any one of, any combination of, or all of a degumming step, a chemical treating step, a water-wash step, a demetallation step, a bleaching step, a full (or partial) hydrogenation step, a hydrolysis step, an acid gas removal step, and/or a water removal step. The pre-treatment also typically includes a step of removing impurities from the feedstock, including any suitable removal of solids from a liquid, including filtration, centrifugation, and sedimentation; and removing volatiles from liquid, e.g., by evaporation. In the pre-treatment, the renewable feedstock, as previously defined, is purified and a purified renewable feedstock is obtained.

In one embodiment the pre-treatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can be followed by an evaporation step, where especially silicon and phosphorous containing compounds are removed. Heat treatment can also be followed by filtration as an addition or an alternative to evaporation. When the feedstock includes brown grease or acidulated soap stock the pre-treatment comprises typically heat treatment with or without a filter-aid (adsorbent) followed by filtration and possible bleaching.

In one embodiment the pre-treatment is selected from hydrolysis followed by separation, whereby the feedstock is mixed with water and the mixture is heated at a temperature of from 80° C. to 325° C., preferably 180° C. to 300° C., more preferably 200° C. to 280° C., in a residence time from 1 to 300 min. The hydrolysis step is followed by a separation step of the water and the treated feedstock.

In one embodiment the pre-treatment is selected from heat treatment with adsorbent (HTA) optionally followed by flash evaporation. Heat treatment with adsorbent (HTA) can be performed at a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt % to 10 wt %, such as 0.5 wt %.

In one embodiment, the pre-treatment is selected from bleaching. Bleaching can be conducted by acid addition in an amount of from 500 to 5000 ppm based on feed. The bleaching treatment can be performed at a temperature from 60° C. to 90° C. and including a drying step at 110° C. to 130° C. The bleaching is finished by a filtration step to remove formed solids and possible filter aids.

In some embodiments, pre-treatment comprises heat treatment (HT) and bleaching. In other embodiments, the pre-treatment comprises heat treatment (HT) with alkali addition and bleaching. In other embodiments, the pre-treatment comprises heat treatment with adsorption (HTA) followed by flash (removal of light components comprising Si components) and bleaching.

In addition, the pre-treatment may or may not include additional steps such as removal of solids (using technologies such as centrifugation or filtration) before and/or after HT or HTA, water washing, degumming, hydrolysis, distillation, strong acid treatment, a second bleaching step, or any combination of the mentioned methods.

Feedstock suitably purified by pre-treatment prolongs the catalyst life cycle in the hydroprocessing plant (hydrodeoxygenation and subsequent reactions like isomerization or cracking).

Heat for the various processes used in pretreating may be provided using hot thermal oil heated within the hydrogen plant. Further, steam generated in the hydrogen plant may be used within the pretreatment area, such as for driving pumps, providing heat, dilution, or other various purposes associated with pretreatment steps being used within a particular embodiment.

### Hydroprocessing

The renewable feedstocks, or pretreated renewable feedstocks, as described above are subjected to hydroprocessing to convert the renewable feedstocks into sustainable fuels, such as sustainable aviation fuels or renewable diesel fuels. Hydroprocessing, as used herein, may include hydrotreatment and isomerization, among other reactions.

The term “hydrotreatment” as used herein refers to a catalytic process for converting organic material by all means of molecular hydrogen. In one aspect, hydrotreatment removes oxygen from oxygen-containing organic compounds as water by hydrodeoxygenation (HDO). Additionally or alternatively, hydrotreatment may: remove sulfur from sulfur-containing organic compounds as hydrogen sulfide (H2S), such as by hydrodesulfurization (HDS); remove nitrogen from nitrogen-containing organic compounds as ammonia (NH3), such as by hydrodenitrfication (HDN); remove halogens, for example chlorine, from halogen-containing organic compounds, such as by hydrodechlorination (HDCl); and/or remove aromatic compounds by hydrodearomatization (HDA).

“Hydrodeoxygenation” (HDO) refers to processing of sustainable feedstocks, such as those comprising triglycerides or other fatty acid derivatives or fatty acids, to effect the removal of carboxyl oxygen as water by means of molecular hydrogen under the influence of a catalyst. The hydrodeoxygenation, for example, may be accompanied by hydrodesulfurization, hydrodenitrification, and/or hydrodechlorination reactions.

Removing oxygen from the sustainable feedstock may also be done by decarboxylation where oxygen is removed in the form of CO2, and by decarbonylation where oxygen is removed in the form of CO.

“Hydroisomerization” or “isomerization” as used herein refers to reactions that cause the branching of hydrocarbon chains of hydrotreated feedstock. Branching of hydrocarbon chains improves properties of the resulting fuels, such as cold properties, where the isomerized hydrocarbons have better cold properties compared to merely hydrotreated feedstock. Better cold properties refer to a lower temperature value of a pour point or a freeze point, for example. The formed isoparaffins may have one or more side chains, or branches, typically methyl or ethyl groups.

Typically, the HDO and isomerization, such as hydroisomerization, reactions take place in the presence of a catalyst suitable for the reaction. Reaction conditions and catalysts typically used in the hydrodeoxygenation of biological material and in the isomerization of resultant n-paraffins are known in the art and disclosed in several documents.

The hydrotreatment including deoxygenation and isomerization reactions may be conducted in a single reactor conducting hydrodeoxygenation and isomerization reactions in same or subsequent catalyst beds, in multiple catalyst bed systems, or in separate reactors. Preferably, the deoxygenation and isomerization reactions in the hydrotreatment are conducted in separate deoxygenation and isomerization steps, in subsequent catalyst beds, in the same reactor or in separate reactors. Most preferably, the deoxygenation and isomerization reactions are conducted in separate reactors.

### Hydrodeoxygenation

Process conditions for hydrodeoxygenation are generally known. For example, the hydrodeoxygenation of renewable feedstocks may be carried out on sulfided metal catalyst or a metal sulfide catalyst. The metal may comprise one or more Group VI metals, such as Mo or W, or one or more Group VIII non-noble metals such as Co or Ni. The catalyst may be supported on any convenient support, such as alumina, silica, zirconia, titania, amorphous carbon, zeolite, molecular sieves or combinations thereof. Typically, the metal is impregnated or deposited on the support as metal oxides and then typically converted into their sulfides. Examples of typical catalysts for hydrodeoxygenation are molybdenum containing catalysts, NiMo, CoMo, CoNiMo or NiW catalysts, supported on alumina or silica, but many other hydrodeoxygenation catalysts are known in the art, and have been described together with or compared to NiMo and/or CoMo catalysts. The hydrodeoxygenation is preferably carried out under the influence of the catalysts in the presence of hydrogen gas.

The hydrodeoxygenation may be performed under a hydrogen pressure from 10 to 200 bar (absolute), at temperatures from 200° C. to 400° C., and at liquid hourly space velocities of 0.2 h⁻¹ to 10 h⁻¹. During a hydrodeoxygenation step using a sulfided catalyst, the sulfided state of the catalyst may be maintained by addition of sulfur in the gas phase or by using a feedstock having sulfur containing mineral oil blended with the renewable feedstock. The sulfur content of the total feed being subjected to hydrodeoxygenation may be, for example, in the range of 50 ppmw to 20000 ppmw, for example.

Effective conditions for hydrodeoxygenation may reduce the oxygen content of the renewable feedstock to less than 1 wt %, such as less than 0.5 wt % or even less than 0.2 wt %. In some embodiments, the conditions may be selected to yield partial hydrodeoxygenation corresponding to a deoxygenation of at least 40 wt %, at least 50 wt % or at least 75 wt %, based on weight of the feedstock.

In some embodiments, preparing a paraffinic hydrocarbon intermediate from a renewable feedstock includes subjecting the feedstock to a deoxygenation treatment. In embodiments herein, the deoxygenating method is not particularly limited and any suitable method may be employed. Suitable methods are, for example, hydrotreating, such as hydrodeoxygenation (HDO), catalytic hydrodeoxygenation (catalytic HDO), catalytic cracking (CC), or a combination thereof. Other suitable methods include decarboxylation and decarbonylation reactions, either alone or in combination with hydrotreating.

In one embodiment, the deoxygenation treatment, to which the renewable feedstock is subjected, is hydrotreatment. The renewable feedstock may be subjected to hydrodeoxygenation (HDO) using a HDO catalyst. Catalytic HDO is a common way of removing oxygen and has been extensively studied. As the HDO catalyst, a HDO catalyst comprising hydrogenation metal supported on a carrier may be used. Examples include a HDO catalyst comprising a hydrogenation metal selected from a group consisting of Pd, Pt, Ni, Co, Mo, Ru, Rh, W or a combination of these, preferably from Ni, Mo or W. Alumina or silica is suitable as a carrier, among others. The hydrodeoxygenation step may, for example, be conducted at a temperature of 100-500° C. and at a pressure of 10-150 bar (absolute).

In one embodiment, the hydrotreatment, preferably hydrodeoxygenation, is performed under a hydrogen pressure from 10 to 150 bar, such as 20-120 bar, such as 30-100 bar, and at a temperature from 200° C. to 400° C., such as 250° C. to 380° C., such as 280° C. to 360° C.

In one embodiment, the hydrotreatment is performed in the presence of one or more catalyst(s) selected from hydrogenation metal on a support, such as a catalyst selected from a group consisting of Pd, Pt, Ni, Co, Mo, Ru, Rh, W or any combination thereof, preferably a catalyst comprising one or more catalyst(s) selected from CoMo, NiMo, NiW, CoNiMo on a support, for example an alumina support.

The hydrodeoxygenation may be accompanied, in various embodiments, by hydrodesulfurization, hydrodearomatization, hydrodenitrification, olefin saturation and/or hydrodechlorination reactions.

Preparing a hydrotreated feedstock from the renewable feedstock may also include a step of hydrocracking hydrocarbons in the feedstock, in some embodiments. Thus, the chain length of the hydrocarbons may be adjusted and the product distribution of the produced mixture of hydrocarbons can be indirectly controlled.

### Intermediate Separations

The effluent of the hydrodeoxygenation step, the hydrodeoxygenated stream, may be purified further before feeding it to a hydroisomerization step. Typically, the purification includes subjecting the effluent to a gas-liquid separation, removing gases such as carbon monoxide, carbon dioxide, water, hydrogen sulfide, ammonia and low boiling hydrocarbons, such as C1-C4, from the liquid hydrocarbon stream, for example. In the gas-liquid separation, the hydrotreated effluent is separated into a gaseous stream and into a hydrotreated liquid stream, which separation may be a stripping step or be followed by a stripping step, where the hydrotreated liquid stream may be stripped with a stripping gas, such as hydrogen. This may occur in a high temperature and/or high-pressure separation step, for example, at a temperature between 300° C. and 330° C. and pressure between 40 bar and 50 bar.

In one embodiment, the obtained purified liquid hydrocarbon stream may be separated into suitable carbon number ranges for further processing, such as by distillation. The purification may further include removing C17 and higher hydrocarbons from the effluent stream by distillation. Following intermediate separations, the hydrodeoxygenated liquid stream fed to the hydroisomerization step may include at least 92 wt %, such as greater than 95 wt % or greater than 99 wt %, paraffins, based on the total weight of the hydrocarbons. Typically, the reminder comprises some oxygen. The effluent stream is still mainly in liquid form. The amount of n-paraffins is high, and may contain more than 85 wt %, such as greater than 95 wt %, based on the total weight of the hydrocarbons.

It is generally known that alkane and paraffin are synonyms and can be used interchangeably. Isoparaffins (i-paraffins) are branched, open chain paraffins, and normal paraffins (n-paraffins) are unbranched linear paraffins. In the context of this disclosure, the term “paraffin” refers to n-paraffins and/or isoparaffins. Similarly, the term “paraffinic” refers herein to compositions comprising n-paraffins and/or isoparaffins.

### Isomerization

The paraffinic hydrocarbons recovered from the intermediate separation step may then be subjected to isomerization to enhance a concentration of isoparaffins therein and to improve various properties of the hydrocarbon mixtures recovered therefrom, such as pour point or cloud point, among other properties. Isomerization causes branching of hydrocarbon chains of the hydrotreated feedstock. Branching of hydrocarbon chains improves e.g. cold properties, the isomerized hydrocarbons have better cold properties compared to merely hydrotreated feedstock. Better cold properties refer to e.g. a lower temperature value of a pour point and/or cloud point. The formed isoparaffins may have one or more side chains, or branches, typically methyl or ethyl groups.

The isomerization step may be carried out in the presence of an isomerization catalyst, and preferably in the presence of hydrogen added to the isomerization process. The presence of added hydrogen is particularly preferable to reduce catalyst deactivation. Suitable isomerization catalysts contain a molecular sieve and/or a metal selected from Group VIII of the periodic table and optionally a carrier. Preferably, the isomerization catalyst contains SAPO-11, or SAPO-41, or ZSM-22, or ZSM-23, or fernerite, and Pt, Pd, or Ni, and Al2O3, or SiO2. Typical isomerization catalysts are, for example, Pt/SAPO-11/Al2O3, Pt/ZSM-22/Al2O3, Pt/ZSM-23/Al2O3, and Pt/SAPO-11/SiO2. The catalysts may be used alone or in combination. The isomerization is performed, for example, in the presence of one or more catalyst(s) comprising a Group VIII metal on a support, where the support is selected from silica, alumina, clays, titanium oxide, boron oxide, zirconia, which can be used alone or as a mixture, preferably silica and/or alumina.

The isomerization step, or hydroisomerization step, may be conducted at a temperature of 200° C. to 500° C., for example, and at a pressure of 10-150 bar (absolute), for example.

Following isomerization, the resulting hydrocarbons may be separated to recover the desired sustainable fuel fractions.

### Separations to Recover the Sustainable Fuel

There may be further steps included either combined with the hydroisomerization step, or thereafter, as separate process steps. These may comprise further purification. fractionation, or stabilization. Typically, such additional process steps allow better control of desired properties of the effluent.

The isomerization step may comprise optional stabilization, such as by stripping before the effluent is exiting the reactor or there may be a separate optional stripping step after the isomerisation step, such as an additional stripping column.

### Separation of the Aviation Fuel Fractions

The hydroisomerized stream, optionally the stabilized hydroisomerized effluent from the hydroisomerization, is subjected to separation using conventional separation processes, such as fractionation through distillation at atmospheric pressure and/or at reduced pressure. The fractionation is used to separate the hydroisomerized stream at least into a fraction suitable for use as sustainable aviation fuel, or components thereof, or renewable diesel, among other fuels or fuel components.

In some embodiments, the hydroisomerized effluent is separated to recover a recycle gas fraction (including unreacted hydrogen), a light hydrocarbon fraction (e.g., C1-C4 hydrocarbons), a naphtha fraction (e.g., C5-C9 hydrocarbons), a sustainable aviation fuel fraction (e.g., C9-C16 or C10-C16 hydrocarbons), and a heavies fraction (e.g., C17+ hydrocarbons). In some embodiments, the sustainable aviation fuel fraction has an initial boiling point at atmospheric pressure of at least 150° C. and a final boiling point of up to 290° C. The sustainable aviation fuel may include, for example, greater than 40 wt %, greater than 60 wt % or greater than 70 wt % isoparaffins in some embodiments.

In some embodiments, the light hydrocarbon fraction is further separated into a fraction comprising renewable C1 or C1-C2 hydrocarbons, and a further fraction or fractions including renewable C2 hydrocarbons, renewable C3 hydrocarbons, renewable C4 hydrocarbons, or mixtures of two or more of these (e.g., C2+C3, C3+C4, or C2+C3+C4).

The heavies fraction may be recycled to the isomerization reactor as a diluent and/or for continued reaction to produce additional SAF. Alternatively, the heavies fraction, or a portion thereof, may be recovered for use as a diesel fuel or another fuel fraction or sent offsite or to a different portion of the facility for further conversion to useful or desirable products.

Light hydrocarbons recovered from the hydroprocessing plant may be fed to the hydrogen plant for use as a fuel or as a feedstock for producing hydrogen. In some embodiments, methane, ethane, propane, and/or butanes are fed as a fuel to the fuel-fired reactors of the hydrogen plant. In other embodiments, the methane, ethane, propane, and/or butanes are fed as a feedstock for production of hydrogen within the hydrogen plant. Naphtha range hydrocarbons recovered from the hydroprocessing plant may also be fed as a fuel or feedstock to the hydrogen plant.

Hydrogen produced in the hydrogen plant may be fed to one or more reactors or separators in the hydroprocessing plant. For example, hydrogen produced in the hydrogen plant may be fed to the hydrodeoxygenation reactor, the hydroisomerization reactor, as a stripping medium in a stripper (such as an intermediate separator between HDO and hydroisomerization), or other reactors or separators, as needed or as beneficial to the operations therein.

Heated thermal oil, as produced in the hydrogen plant, may be fed to the hydroprocessing plant and the heat therein may be used to supply, in various embodiments or combinations, heat for the HDO reaction, heat for the isomerization reaction, or heat for product separations, such as preheating feed to a separator or distillation column or heat for reboiling components being separated in a distillation column.

Embodiments herein thus provide for the integrated production of hydrogen and sustainable fuels using the above-described systems (hydroprocessing, hydrogen production, and optional pretreatment).

In a first aspect, embodiments herein relate to a process for producing fuels. The process includes converting a hydrocarbon feed in a furnace of a hydrogen plant to produce hydrogen. The process further includes heating a thermal oil in a convection zone of the furnace within the hydrogen plant to produce a heated thermal oil. Further, the process includes reacting and separating the hydrogen and a hydrocarbon feedstock in a hydroprocessing plant to recover one or more fuel fractions, where, in the hydroprocessing plant, heat for the reacting and separating within the hydroprocessing plant is provided by the heated thermal oil from the hydrogen plant. In some embodiments, the hydroprocessing plant does not include a fuel combusting furnace.

In a second aspect, embodiments herein relate to a process for producing fuels. The process includes combusting a fuel and preheated combustion air in a reforming reactor furnace comprising a combustion zone and a convection zone receiving a flue gas from the combustion zone. In the convection zone, a hydrocarbon feed is preheated to form a preheated hydrocarbon feed, and combustion air is preheated to provide the preheated combustion air. Additionally, within the convection zone, water is heated to make steam, or steam is heated to make superheated steam, and a thermal oil is heated to form a heated thermal oil. The process further includes converting the preheated hydrocarbon feed in the reforming reactor to produce hydrogen. The produced hydrogen and a hydrocarbon feedstock are then fed to a hydroprocessing reaction zone comprising one or more hydroprocessing reactors in which the hydrogen and the hydrocarbon feedstock are reacted to produce a hydroprocessed effluent comprising fuel range hydrocarbons having from 6 to 24 carbon atoms (C₆ to C₂₄ hydrocarbons), for example, as well as lighter hydrocarbons (C1-C5 hydrocarbons). The hydroprocessed effluent is then separated in one or more separators to recover one or more fuel fractions. The reacting and separating steps include one or more of: preheating the hydrogen upstream of a reactor of the one or more hydroprocessing reactors using the heated thermal oil; preheating the hydrocarbon feedstock upstream of a reactor of the one or more hydroprocessing reactors using the heated thermal oil; heating a reboiler of a separator of the one or more separators using the heated thermal oil; and, heating a feed to a separator of the one or more separators using the heated thermal oil.

### Integrated Hydrogen Production and Sustainable Fuels Production

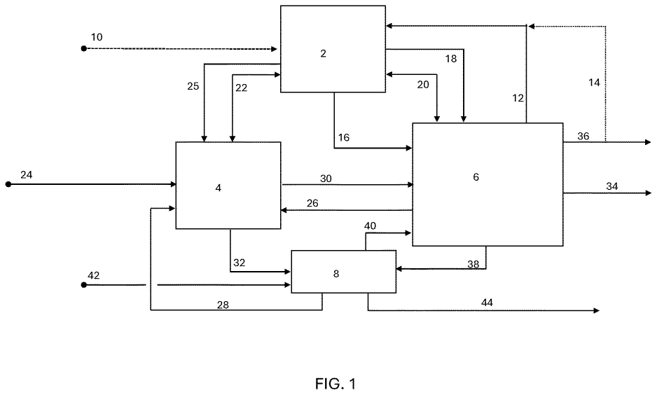

Systems and processes herein and as described above advantageously integrate hydrogen production processes and sustainable fuels production processes to provide an overall low carbon footprint process to make fuels. One example of such an integrated process is illustrated in FIG. 1, which presents a generic block flow diagram of the process and systems used therein.

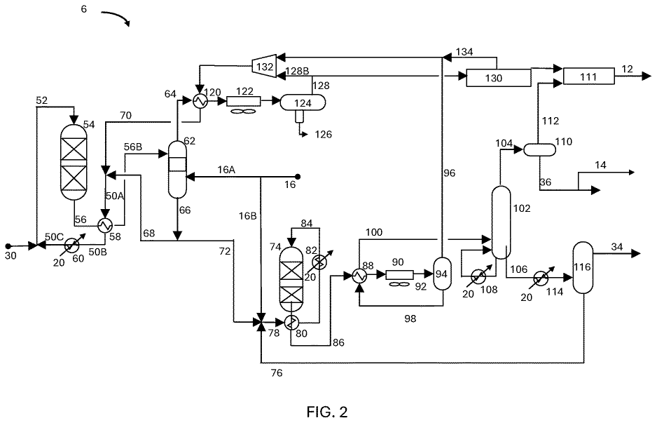

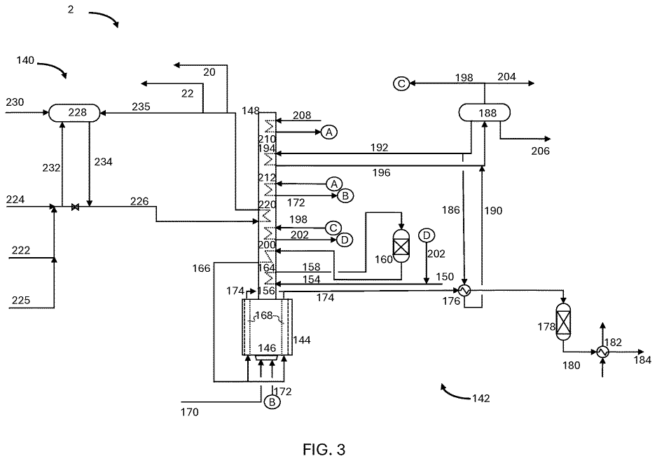

In the embodiment of FIG. 1, the overall process includes a hydrogen manufacturing plant 2, a pretreatment plant 4, a hydroconversion plant 6, and a water treatment facility 8. Examples of a hydrogen manufacturing plant 2 and hydroprocessing plant 6 useful in embodiments herein are illustrated in FIG. 3 and FIG. 2, respectively, each described in more detail below.

In the hydrogen manufacturing plant 2, a fuel is combusted to provide heat for converting a hydrocarbon feedstock to hydrogen and carbon oxides. The fuel may be provided by a natural gas stream 10, a light hydrocarbon feedstock 12 (i.e., C1 to C4 hydrocarbons) received from hydroprocessing plant 6, or a naphtha range hydrocarbon feed 14 received from the hydroprocessing plant. The fuel may be additionally provided by hydrogen produced internally within hydrogen manufacturing plant 2.

The heat from combusting the fuel is then used for converting a light hydrocarbon feedstock via reforming and optionally water-gas shift reactions. The light hydrocarbon feedstock may be provided by a natural gas stream 10, a light hydrocarbon feedstock 12 received from hydroprocessing plant 6, or a naphtha range hydrocarbon feed 14 received from the hydroprocessing plant.

Following reforming and optional water-gas shift, the reaction effluent is separated to recover a hydrogen stream 16. As noted above, the hydrogen produced may be fed to the hydroprocessing plant.

Excess heat from fuel combustion in the hydrogen manufacturing plant 2 is recovered. Specifically, in embodiments herein, a thermal oil is heated to produce a heated thermal oil and water/steam is heated to produce steam/superheated steam. The steam/superheated steam 18 and the heated thermal oil 20 are provided to the hydroprocessing plant 6 to provide heat for the reactions carried out therein, and heated thermal oil 22 may also be provided to the pretreatment plant 4 to provide heat as required therein. The thermal oil may be processed in a circulation loop (illustrated as the double arrow lines 20, 22) to and from the hydroprocessing plant and the pretreatment plant 4. While not illustrated in the simplified process flow diagram of FIG. 1, pumps and compressors within the hydrogen plant and the hydroprocessing plant may be driven by high pressure steam. Further excess heat may be recovered via combustion air preheating.

Thus, the hydrogen manufacturing plant may be integrated, as illustrated, with respect to feedstocks (light hydrocarbons 12, naphtha 14) to produce hydrogen, as well as utilities (thermal oil 20, 22 circulation loops, steam 18) to each of the pretreatment plant 4 and hydroprocessing plant 6.

In the pretreatment plant 4, a renewable feedstock 24 undergoes pretreatment, which may include one or more of heat treatment, evaporation, contaminant removal (metals, halogens, nitrogen, sulfur, solids, etc.), water washing, and other possible pre-treatment steps as noted above. Heat may be provided for the heat treatment, evaporation, or other steps conducted in the pretreatment unit 4 utilizing the circulating hot thermal fluid 22 received from the hydrogen manufacturing plant 2 and/or steam provided via flow lines 25 or 26 received from either the hydrogen manufacturing plant 2 or the hydroprocessing facility 6, respectively. Water washing or other steps may be performed using treated water 28 provided by the water treatment unit 8.

Pretreatment of renewable feedstock 24 results in a pretreated feedstock 30 suitable for hydroprocessing in the hydroprocessing unit 6. Wastewater 32, which may include steam condensate and/or wash water, among other water producers, may also be recovered from the pretreatment unit 4 and fed to the water treating unit 8 for treatment and recycling, as necessary.

The hydroprocessing plant 6 receives the pretreated feed 30, and converts the pretreated feed via reaction with hydrogen 16, to sustainable aviation fuel 34, naphtha 36, and light hydrocarbon fraction 12. Heat for the reaction and separations occurring in the hydroprocessing plant is provided at least in part by the heated thermal fluid 20, and steam 18 may be used for heating and/or as a utility stream to drive pumps or other equipment within the hydroprocessing plant.

Thus, the hydroprocessing plant may be integrated, as illustrated, with respect to the feedstocks or fuel (12, 14) provided to the hydrogen manufacturing plant 2, hydrogen 16, steam 18, and thermal oil 20 received from the hydrogen manufacturing plant 2, and steam 26 provided to the pretreatment unit 4. Water wash and/or sour water recovered as a reaction byproduct from separations within the hydroprocessing plant may be fed as wastewater stream 38, and treated wash water 40 may be returned to the hydroprocessing plant as required.

In addition to the above-noted wastewater streams 32, 38, and treated water streams 28, 40, water treatment unit 8 may also receive a makeup water stream 42 and may discharge a water disposal stream 44, as required.

An example of a hydroprocessing plant 6 that may be used according to embodiments herein is illustrated in FIG. 2, where like numerals represent like parts. The simplified process flow diagram includes major components required in the embodiment illustrated, while other components, such as pumps, valves, drums, controls, and other pieces of equipment are not illustrated, but understood by one skilled in the art as present.

A renewable feedstock or a pretreated renewable feedstock 30 is mixed with hydrogen and diluent provided by stream 50C, forming a mixed feed 52. Mixed feed 52 is then fed to hydrodeoxygenation reactor 54 containing catalyst for facilitating the hydrodeoxygenation and other reactions for converting the renewable feedstock to paraffins. The hydrodeoxygenated effluent 56 is then recovered from reactor 54.

Heat may be recovered from hydrodeoxygenated effluent 56 in feed-effluent exchanger 58, warming a hydrogen and diluent feed stream 50A, producing a warmed hydrogen and diluent feed stream 50B while cooling the hydrodeoxygenated effluent. Warmed hydrogen and diluent feed stream 50B is then further heated in reaction feed heater 60 to provide heated hydrogen and diluent feed stream 50C, which contains the necessary heat for the hydrodeoxygenation reaction, where the hydrogen and diluent are heated via indirect heat exchange with heated thermal oil 20 circulating from the hydrogen manufacturing plant.

The cooled hydrodeoxygenated effluent 56B is then fed to a hydrogen stripper 62. Hydrogen stripper 62 removes unreacted hydrogen and other light gases from the hydrodeoxygenated effluent, producing a gas stream 64, recovered as an overheads product from the stripper, and a paraffin-containing stream 66, recovered as a bottoms product from stripper 62. A portion of the bottoms product in paraffin-containing stream 66 may be recycled as a diluent 68 and combined with hydrogen 70 to form the hydrogen and diluent stream 50A, processed as described above, being heated, mixed with the renewable feedstock and fed to the hydrodeoxygenation reactor. A remaining portion 72 of paraffin-containing stream 66 may be fed to isomerization reactor 74.

A first portion 16A of hydrogen 16 provided from the hydrogen plant 2 (FIG. 1) may be used as a stripping medium within hydrogen stripper 62. A second portion 16B of hydrogen 16 is mixed with paraffin-containing stream 72, and recycle paraffins 76 to form isomerization reactor feed stream 78.

Isomerization reactor feed stream 78 is preheated in feed-effluent exchanger 80 and further heated to reaction inlet temperature via feed heater 82, producing a heated isomerization feed 84. Feed heater 82 may be used to heat the isomerization reactor feed up to reactor inlet temperature via indirect heat exchange with heated thermal oil 20 circulating from the hydrogen manufacturing plant. In isomerization reactor 74, paraffins are converted to isoparaffins, producing an isomerized effluent 86, which is initially cooled via feed-effluent exchanger 80 as noted above.

Isomerized effluent 86 may be further cooled via exchanger 88 and air-cooled exchanger 90, and the resulting cooled isomerized effluent 92 may then be fed to flash drum 94 to separate unreacted hydrogen stream 96, recovered as an overheads vapor stream, from the isomerized effluent, recovered as a bottoms liquid stream 98 from drum 94. Bottoms liquid stream 98 may then be warmed against isomerized effluent 86, producing a warmed isomerized hydrocarbon stream 100 fed to product stripper 102.

Product stripper 102 may initially separate the isomerized hydrocarbons into an overheads stream 104 and a bottoms stream 106. Overheads stream 104 may include C1 to C7, C8 or C9 hydrocarbons, while bottoms stream 106 may contain C8+ or C9+ hydrocarbons, such as C8, C9 or C10 to C36 hydrocarbons, the max carbon number depending upon the renewable feedstock used. Heat to drive the separations in product stripper 102 may be input through reboiler 108 by indirect heat exchange with heated thermal oil 20 circulating from the hydrogen manufacturing plant.

Overheads stream 104 may then be fed to stabilizer 110 to separate the C1 to C8/C9 hydrocarbons into a light hydrocarbon fraction 112 and a naphtha fraction 36. The C1 to C4 hydrocarbons in the light hydrocarbon fraction 112 may then be treated in H2S removal unit 111 to remove any entrained hydrogen sulfide and then the treated light hydrocarbon fraction 12 may be fed to the hydrogen plant 2 as a fuel or reformer feedstock. The naphtha fraction 36 may be recovered as a sustainable fuel, and/or a portion 14 of the naphtha fraction may be fed to the hydrogen plant 2 as a fuel or reformer feedstock.

The bottoms stream 106 from stripper 102 may then be heated in exchanger 114 by indirect heat exchange with heated thermal oil 20 circulating from the hydrogen manufacturing plant and fed to product fractionator 116. Product fractionator 116 separates the C8+ or C9+ hydrocarbons into the desired product, sustainable aviation fuel fraction 34 or renewable diesel, and a recycle fraction 76, fed as a diluent or for continued reaction within isomerization reactor 74.

Hydrogen 64 and other light gases recovered from stripper 62 may be cooled via one or more exchangers 120, 122 and fed to drum 124 for removal of any condensate 126. Non-condensed gases, including hydrogen, may then be recovered from drum 124 via stream 128 and fed to either recycle gas purification unit 130 or recycle gas compression unit 132, which may contain one or multiple compressors. Treated gas 134, including recycle hydrogen, recovered from gas purification unit 130 may be combined with unreacted hydrogen stream 96 and recycle gas 128B and compressed in compressor unit 132 for ultimate feed as hydrogen stream 70 and mixed with recycle/diluent stream 68, forming hydrogen and diluent feed stream 50A.

As described, heat for conducting the reactions in hydrodeoxygenation reactor 54 and isomerization reactor 74, as well as heat for performing the separations in product stripper 102 and product fractionator 116 are provided via indirect heat exchange with heated thermal fluid circulating from the hydrogen manufacturing plant.

While not illustrated in the simplified process flow diagram of FIG. 2, pumps and compressors within the hydroprocessing plant may be driven by high pressure steam provided from the hydrogen manufacturing plant, or other heat exchangers may utilize heat provided by steam, such as high-pressure steam, from the hydrogen manufacturing plant. Further, steam produced in heat exchangers (also not illustrated) such as for cooling reaction streams or other hot streams within the system, or high-pressure steam partially consumed within the hydroprocessing plant to drive pumps or compressors, may be recovered as medium pressure steam. Such medium pressure steam may be fed to the pretreatment unit as described above.

One example of the hydrogen manufacturing plant 2 that may be used according to embodiments herein is illustrated in FIG. 3, where like numerals represent like parts. The simplified process flow diagram includes major components required in the embodiment illustrated, while other components, such as pumps, valves, drums, controls, and other pieces of equipment are not illustrated, but understood by one skilled in the art as present.

Hydrogen plant 2 includes a thermal oil circulation system 140 and a reaction system 142. Reaction system 142 is used to convert a hydrocarbon feed, such as methane, to hydrogen and carbon oxides. Methane will be used in the following description, but other hydrocarbon feeds, such as ethane, propane, or butane, among others, including light hydrocarbon stream 12 or naphtha stream 14 from the hydroprocessing unit may also be used. Reaction system 142 includes, among other components, a fuel fired reactor 144 having a combustion zone 146 and a convection zone 148. Disposed within convection zone 148 are multiple heat exchange coils to recover heat from the combustion gas.

A reformer feedstock 150, such as methane, may be mixed with steam 202 to form diluted feedstock 154. The mixture of methane and steam 154 may flow through a heat exchange coil 156 to heat the mixture and recover a preheated mixture 158. Heat exchange coil 156 may be disposed at a lowermost portion of convection zone 148. The preheated mixture 158 may then be fed to prereformer 160 for partial conversion of the methane to hydrogen and carbon oxides via reaction with water. The partially reformed effluent 162 may then be further heated in heat exchange coil 164 to form a heated feed stream 166. Heated feed stream 166 is then directed to the fuel-fired reforming reactor for additional conversion to hydrogen and carbon oxides in reformer tubes 168.

Fuel line 170 may be configured to provide a fuel to burners of the fuel-fired reforming reactor 144, along with oxygen-containing gas 172 (air, enriched air, pure oxygen). Reforming the methane feed may occur at a temperature ranging from 700° C. to 900° C., for example. The fuel provided via stream 170 may include natural gas, and/or may include light hydrocarbon gases recovered from the hydroprocessing plant and/or naphtha range hydrocarbons recovered from the hydroprocessing plant, and/or such feeds recovered from downstream separations (not illustrated) within the hydrogen plant.

Reformer effluent 174 recovered from reformer tubes 168 may then be cooled in exchanger 176 and fed to water-gas shift reactor 178 for further production of hydrogen. Shifted effluent 180 may then be recovered, cooled in exchanger 182, and forwarded via flow line 184 for recovery of the hydrogen 16, a portion of which is fed to the hydroprocessing plant, as well as sequestration of carbon dioxide, and other downstream processing as may be typical associated with a hydrogen plant.

Quench of the reformer effluent in exchanger 176 may be performed via indirect heat exchange with water 186 provided from steam drum 188. The resulting steam produced during the quenching process may be returned to steam drum 188 via flow line 190.

Convection zone 148 may include multiple heat exchange coils for heating water and/or steam. For example, water 192 may be fed from steam drum 188 to coil 194 to produce steam 196, which is then returned to the steam drum 188. Steam 198 may be withdrawn from steam drum 188 and superheated in heat exchange coil 200 to produce superheated steam 202, which is then mixed with methane feed stream 150 to form the mixed water-hydrocarbon reformer feed 154 (as illustrated with connectors C and D). Steam 204 and water 206 may be fed from steam drum 188 to other portions of the integrated systems, as required.

Combustion air (or enriched air, pure oxygen) 208 may be preheated in heat exchange coils 210, 212 to provide a preheated combustion air 172 to the burners of combustion zone 146 (as illustrated with connectors A and B).

In addition to the air preheat coils (210, 212), water/steam coils (194, 200) and feed preheat coils (156, 164), a thermal oil heating coil 220 is also disposed in convection zone 148. The thermal oil circulation system includes one or more cool oil returns 222, 224 as may be received, for example, from exchangers 60, 82, 108, 114 in the hydroprocessing unit 6 (FIG. 2). Cool oil returns may also be received from the pretreatment unit 4 (circulation loop 22) (FIG. 1) via one or more cool oil returns 225. The cool oil returned may then be heated within thermal oil heating coil 220 in convection section 148 and circulated via flow circulation loops 20, 22 to the respective exchangers in the pretreatment unit and hydroprocessing plant. The thermal oil circulation unit may additionally include a hot oil drum 228, along with a fresh oil makeup line 230 and one or more flow lines 232, 234, 235 between the circulation loops and the hot oil drum 228 to address the fluctuating heat transfer requirements of the various heaters and the required flows to each heater. Pumps, flow control valves, and other instrumentation and controls associated with the thermal oil circulation system, are not illustrated for simplicity.

The heat recovery in the convection section may be designed to heat the thermal oil such that it may provide the necessary heat and temperature required in the hydroconversion unit (reactors and separators) as well as that of any end users in the pretreatment unit. Integrating in the manners described herein, the hydroprocessing unit does not require its own furnace or heater to provide the required reaction heat and temperature or a dedicated furnace for heating of a thermal oil.

While illustrated in FIG. 3 as an up-fired reforming reactor, other configurations may also be used, such as a down-fired reactor having burners at a top of the reaction furnace and a flue gas exhaust located at a lower portion of the reaction furnace, or a side-fired reactor, for example.

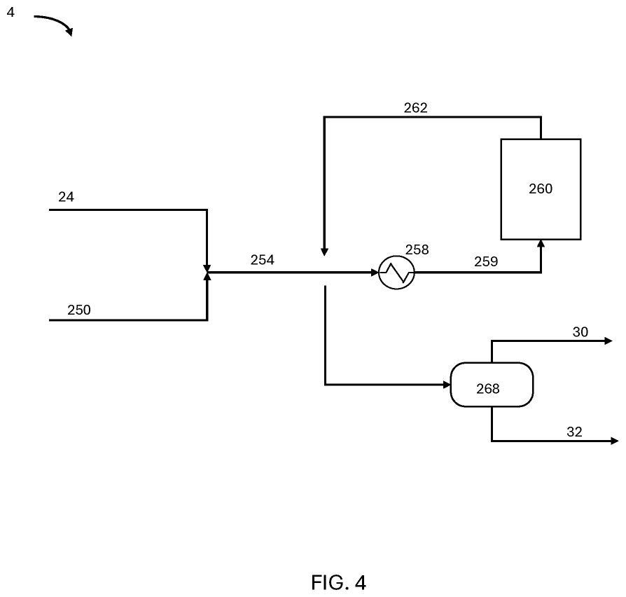

FIG. 4 illustrates a pre-treatment system 4 useful in embodiments herein. In this feed pretreatment system, the feedstock is pretreated via hydrolysis, thermal hydrolysis, or thermal only, followed by separations. A renewable feedstock 24, such as fats, oils, greases, or other hydrocarbons, is initially mixed with a treatment solution 250, which may include water 28 (returned from water treatment facility 8, FIG. 1). The renewable feedstock 24 and treatment solution 250 may be pumped from respective storage or preparation vessels (not illustrated) and then mixed to form a mixed feed 254.

The mixed feed 254 may then be heated in a heater 258 and the heated mixed feed 259 then fed to a hydrolysis reactor 260, such as a thermal hydrolysis reactor. The effluent 262 from the hydrolysis reactor is then fed to oil-water separator 268 for separation of the water and contaminants from the treated renewable feedstock 30, which may be forwarded to the hydroprocessing unit 6. The recovered water and contaminants may be forwarded via flow line 32 to the water treatment unit 8 (FIG. 1) for recovery and recycle of the water.

In the pretreatment area illustrated in FIG. 4, embodiments herein contemplate heating of the mixed feed 254 in heater 258 and/or within hydrolysis reactor 260 using thermal oil heated in the hydrogen plant 2 and circulated via circulation loop 22 (see FIG. 1).

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for producing fuels, the process comprising:
converting a hydrocarbon feed in a furnace of a hydrogen plant to produce hydrogen;
heating a thermal oil in a convection zone of the furnace to produce a heated thermal oil;
reacting and separating the hydrogen and a hydrocarbon feedstock in a hydroprocessing plant to recover one or more fuel fractions;
in the hydroprocessing plant, providing heat for the reacting and separating using the heated thermal oil.

2. The process of claim 1, wherein the hydroprocessing plant does not comprise a fuel combusting furnace.

3. A process for producing fuels, the process comprising:
combusting a fuel and preheated combustion air in a reforming reactor furnace comprising a combustion zone and a convection zone receiving a flue gas from the combustion zone;
in the convection zone:
preheating a hydrocarbon feed to form a preheated hydrocarbon feed;
preheating combustion air to provide the preheated combustion air;
heating water to make steam; and
heating a thermal oil to form a heated thermal oil;
converting the preheated hydrocarbon feed in the reforming reactor to produce hydrogen;
feeding the hydrogen and a hydrocarbon feedstock to a hydroprocessing reaction zone comprising one or more hydroprocessing reactors;
reacting the hydrogen and the hydrocarbon feedstock in the one or more hydroprocessing reactors to produce a hydroprocessed effluent comprising fuel range hydrocarbons having from 6 to 24 carbon atoms (C₆ to C₂₄ hydrocarbons); and
separating the hydroprocessed effluent in one or more separators to recover one or more fuel fractions;
wherein the reacting and separating steps comprise one or more of:
preheating the hydrogen upstream of a reactor of the one or more hydroprocessing reactors using the heated thermal oil;
preheating the hydrocarbon feedstock upstream of a reactor of the one or more hydroprocessing reactors using the heated thermal oil;
heating a reboiler of a separator of the one or more separators using the heated thermal oil; and
heating a feed to a separator of the one or more separators using the heated thermal oil.

4. The process of claim 3, wherein the hydrocarbon feed comprises one or more of a natural gas feedstock, C1 to C4 hydrocarbons recovered from the separating of the hydroprocessed effluent, and naphtha range hydrocarbons recovered from the separating of the hydroprocessed effluent.

5. The process of claim 3, wherein the hydrocarbon feedstock comprises fatty acids or esters of fatty acids.

6. The process of claim 3, further comprising pretreating the hydrocarbon feedstock upstream of the one or more hydroprocessing reactors.

7. The process of claim 6, wherein the pretreating comprises:
mixing the hydrocarbon feedstock with an aqueous solution to form a mixed feed;
heating the mixed feed and contacting the mixed feed for a period of time to recover a hydrolyzed effluent;
cooling the hydrolyzed effluent to recover a cooled hydrolyzed effluent; and
separating the cooled hydrolyzed effluent to recover a treated hydrocarbon feedstock and an aqueous phase comprising contaminants removed from the hydrocarbon feedstock.

8. The process of claim 7, wherein the heating of the mixed feed comprises contacting, in indirect heat exchange, the mixed feed and a portion of the heated thermal oil.

9. The process of claim 3, wherein the one or more hydroprocessing reactors comprise a hydrodeoxygenation reactor and a hydroisomerization reactor.

10. A system for producing fuels, the system comprising:
a reforming reactor furnace comprising a combustion zone, for combusting a fuel and preheated combustion air, and a convection zone, configured for receiving a flue gas from the combustion zone;
one or more heating coils disposed within the convection zone and configured for:
preheating a hydrocarbon feed to form a preheated hydrocarbon feed;
preheating combustion air to provide the preheated combustion air;
heating water to make steam; and
heating a thermal oil to form a heated thermal oil;
reaction tubes disposed within the reforming reactor furnace for converting the preheated hydrocarbon feed to produce a reformer effluent comprising hydrogen;
a flow line feeding the hydrogen and a hydrocarbon feedstock to a hydroprocessing reaction zone comprising one or more hydroprocessing reactors;
the one or more hydroprocessing reactors configured for reacting the hydrogen and the hydrocarbon feedstock to produce a hydroprocessed effluent comprising fuel range hydrocarbons having from 6 to 24 carbon atoms (C₆ to C₂₄ hydrocarbons); and
one or more separators for separating the hydroprocessed effluent to recover one or more fuel fractions;
wherein the system comprise one or more of:
a first heat exchanger for preheating the hydrogen using the heated thermal oil, wherein the first heat exchanger is disposed upstream of a reactor of the one or more hydroprocessing reactors;
a second heat exchanger for preheating the hydrocarbon feedstock using the heated thermal oil, wherein the second heat exchanger is disposed upstream of a reactor of the one or more hydroprocessing reactors;
a reboiler, configured for providing reboil vapor to a separator of the one or more separators using heat obtained from the heated thermal oil; and
a third heat exchanger configured for heating a feed to a separator of the one or more separators using the heated thermal oil.

11. The system of claim 10, wherein the hydroprocessing reactors comprise a hydrodeoxygenation reactor and a hydroisomerization reactor.

12. The system of claim 10, further comprising a water-gas shift reactor for receiving the reformer effluent and for producing additional hydrogen therefrom.

13. The system of claim 10, further comprising a feed pretreatment system configured for removing contaminants from the hydrocarbon feedstock upstream of the one or more hydroprocessing reactors.

14. The system of claim 13, wherein the feed pretreatment system comprises:
one or more heaters for heating a mixed feed to a reaction temperature, the mixed feed comprising a mixture of the hydrocarbon feedstock and an aqueous solution;
a hydrolysis reactor for reacting the mixed feed and producing a hydrolyzed effluent; and
an oil-water separator for separating the hydrolyzed effluent to recover a treated hydrocarbon feedstock and an aqueous phase comprising contaminants removed from the hydrocarbon feedstock.

15. The system of claim 14, wherein at least one of the one or more of the heaters and the hydrolysis reactor are configured to receive a portion of the heated thermal oil for indirect heat exchange with the mixed feed.
